(19) United States
(12) Patent Application Publication
(10) Pub. No.: US 2014/0062027 A1
(43) Pub. Date: Mar. 6, 2014

(54) Seal

(71) Applicants: Soeren NEUBERGER, Mannheim (DE); Klaus LANG, Eurasburg (DE); Peter FEIGL, Hoehenrain (DE); Clemens SIMON, Weilheim (DE); Andreas LEDERER, Muenchen (DE); Pascal PENOTY, Hemsbach (DE); Eberhard BOCK, Moerlenbach (DE)

(72) Inventors: Soeren NEUBERGER, Mannheim (DE); Klaus LANG, Eurasburg (DE); Peter FEIGL, Hoehenrain (DE); Clemens SIMON, Weilheim (DE); Andreas LEDERER, Muenchen (DE); Pascal PENOTY, Hemsbach (DE); Eberhard BOCK, Moerlenbach (DE)

(73) Assignee: CARL FREUDENBERG KG, Weinheim (DE)

(21) Appl. No.: 13/603,038

(22) Filed: Sep. 4, 2012

(51) Int. Cl. F16J 15/16

(52) U.S. Cl. CPC F16J 15/16
USPC 277/358

(57) ABSTRACT

A mechanical face seal including a primary ring which is axially movably mounted, and a mating ring (3, 3′, 3″), wherein the primary ring and a mating ring each comprise adjoining sealing surfaces. The primary ring is pressed by a spring against the mating ring. The spring has a bellows-like shape. The spring is made out of an elastomer. The mechanical face seal achieves a small installation space for a mechanical face seal.

### FIELD

The present disclosure relates to a mechanical face seal.

### BACKGROUND

This section provides background information related to the present disclosure which is not necessarily prior art.

From WO 99/00618 A1, a mechanical face seal is known which is manufactured from a relatively large number of individual parts. This is particularly disadvantageous, if a mechanical face seal has to be inserted in an installation space that is small due to the construction.

Here, it is particularly necessary to ensure, in an elaborate manner, that all the individual parts of the mechanical face seal are adapted to the installation space. This can be particularly problematic if tolerances are associated with the individual parts.

In addition, many of the individual parts are needed for only one function. This increases the number of needed parts. Consequently, a function integration is to be sought, which at the same time allows a more advantageous manufacture.

In WO 99/00618 A1, a stationary mating ring 8 is disclosed, which is braced against a cover 6, in FIG. 2. At the same time, a corrugated spring 12 generates a contact pressure pressing the primary ring 7 against the mating ring 8. An O-ring seal 14 made of elastomer is arranged between the corrugated spring 12 and the primary ring 7.

In such mechanical face seals, an axial contact pressure of a spring of approximately 1-8 N/cm² is desirable. During the operation, this contact pressure is decreased or increased by an O-ring friction force, which impedes the function.

The friction force is strongly dependent on the radial compression of the O-ring. Since tolerance is associated with the O-ring, this compression can vary considerably.

Here, a resetting of the primary ring is made more difficult. In addition, a varying compression leads either to large axial forces (several 100 N) on the primary ring or to small axial forces.

The high forces can taper the primary ring, compromising the operational safety. The lower forces can lead to a leak of the seal.

Using the embodiment shown in WO 99/00618 A1, it is difficult to solve this problem.

### SUMMARY

This section provides a general summary of the disclosure, and is not a comprehensive disclosure of its full scope or all of its features.

The present disclosure is therefore based on the problem of designing and further developing a mechanical face seal, in such a manner that it is capable of reliably sealing off two spaces, following a cost-saving and problem-free manufacture of a construction having few components.

A mechanical face seal according to the present disclosure comprises a primary ring which is axially movably mounted, and a mating ring, wherein the primary ring and the mating ring each comprise adjoining sealing surfaces, wherein the sealing surface of the primary ring faces the sealing surface of the mating ring, and wherein the primary ring is pressed by a spring means against the mating ring.

According to the present disclosure, it is provided that the spring means has a bellows-like design.

According to the present disclosure the bellows-like spring means consists of a base body which has intrinsic spring properties. Thus, no additional springs are required to press the spring means against the primary ring.

According to the present disclosure, it has been discovered first that many functions of a mechanical face seal can also be performed if a mechanical face seal has fewer individual parts than the known mechanical face seals of the prior art.

Using the bellows-like spring means, which is constructed as a single piece, a reduction in the number of components is made possible. Moreover, secondary seals can be dispensed with. According to the present disclosure, the design engineer is given the possibility of allowing the forces acting on the primary ring and on the mating ring to engage in such a manner that deformations due to temperature, pressure or rotational speed are minimized. In concrete terms, it has been recognized that, using a bellows-like spring means, a saving of materials can be achieved, force transmission can be improved, and reverse drawing can be reduced. To that extent, a mechanical face seal is indicated which reliably seals off two spaces, after a cost-saving and problem-free manufacture of a construction having few components.

Consequently, the problem mentioned in the background has been solved.

The spring means could be manufactured from an elastomer. The intrinsic spring properties of an elastomer can be used to advantage to produce, for example, the usual, low contact forces for gas seals. This can be ensured over the entire lifetime of the mechanical face even without reinforcements in the elastomer. Moreover, an elastomer provides torque support, a seal against the primary ring and housing, a spring action, and a radial centering. In contrast to the prior art, an elastomer instead of a metal is used as manufacturing material for the bellows-like spring means.

On this background, the elastomer could have a Young's modulus in the range of 10-100 N/mm². Such a spring means is applied against the primary ring in such a manner that, during the operation, the result is a defined deformation of the primary ring.

In particular, the elastomer could have a compression set of less than 30%. The smaller the compression set is, the more constant the spring force of the bellows-like spring means is maintained.

The bellows-like spring means could be applied with a ring-shaped abutment area on the primary ring, and secured with a ring-shaped connection area to a housing, wherein the abutment area and the connection area are connected to each other by at least one resiliently deformable hinge area. Such a spring means can be pulled apart or compressed like an accordion. The abutment area can be associated without problem with a thrust center.

The spring means could have rounded regions which resiliently interconnect ring-shaped disks, wherein the ring-shaped disks are movable resiliently against each other in the axial direction of the shaft. Due to the bellows-like spring means, which is designed as a single piece, and which connects multiple disks and rounded areas to each other, a reduction in the number of components is made possible. Moreover, secondary seals can be dispensed with. The possibility is made available to the design engineer to allow the forces acting on the primary ring and on the mating ring to engage in such a manner that deformations due to temperature, pressure or rotational speed are minimized. By means of the bellows-like spring means, material can be saved, force transmission can be improved, and reverse drawing can be reduced.

The primary ring and the mating ring could have a design with a square or rectangular cross section. The primary ring and the mating ring can be manufactured in a simple manner in large scale industrial series manufacture due to their geometry with square or rectangular cross section. However, it is also conceivable to use different geometries advantageously in large scale industrial series manufacture.

The mechanical face seal described here is preferably exposed to pressure only to a small extent. The mechanical face seal described here can be used particularly in pneumatic applications, in combustion engines, in transmissions, for sealing shafts or for sealing a turbo charger. The mechanical face seal described here is particularly suitable for sealing the crankshaft of a combustion engine. For example, the mechanical face seal can be used on the rear crankshaft end of a motor vehicle. The mechanical face seal described here has a simple design, which provides many design possibilities to adapt the mechanical face seal to the operating conditions. The mechanical face seal is particularly suitable for use as a gas lubricated seal.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a cross-sectional view of a mechanical face seal in which the primary ring is rotatably mounted on the shaft;

FIG. 2 shows a cross-sectional view of a mechanical face seal, in which the primary ring is secured to the housing; and

FIG. 3 shows a cross-sectional view of an additional mechanical face seal, in which the primary ring is secured to the housing.

Corresponding reference numerals indicate corresponding parts throughout the several views of the drawings.

### DETAILED DESCRIPTION

Example embodiments will now be described more fully with reference to the accompanying drawings.

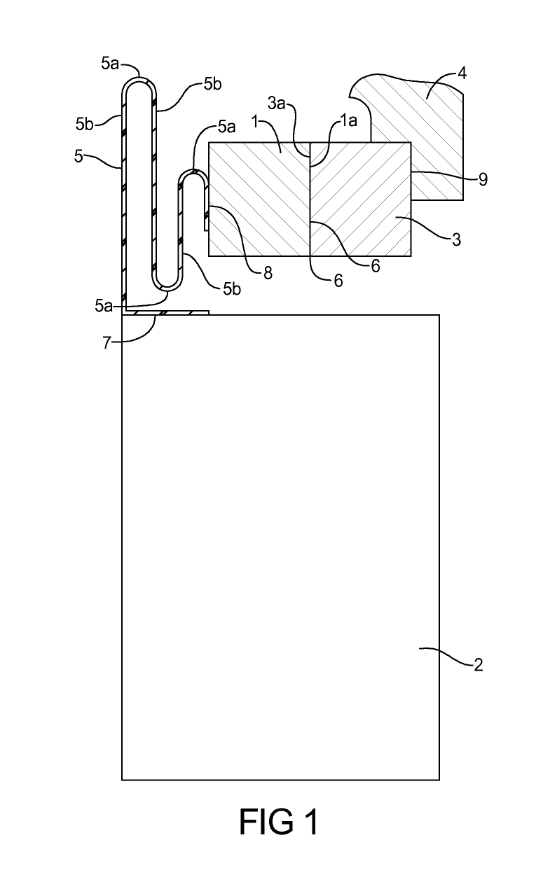

FIG. 1 shows a mechanical face seal comprising a primary ring 1 which is axially movably mounted, and a mating ring 3, wherein the primary ring 1 and the mating ring 3 each comprise adjoining sealing surfaces 1a, 3a, wherein the sealing surface 1a of the primary ring 1 faces the sealing surface 3a of the mating ring 3, and wherein the primary ring 1 is pressed by a spring means 5 against the sealing ring 3. The spring means 5 has a bellows-like design.

FIG. 1 shows a mechanical face seal comprising a rotating primary ring 1 which is rotatably attached to a shaft 2, and a stationary mating ring 3 which is secured to a housing 4, wherein the primary ring 1 and the mating ring 3 each comprise adjoining sealing surfaces 1a, 3a, wherein the sealing surface 1a of the primary ring 1 faces the sealing surface 3a of the mating ring 3, and wherein the primary ring 1 is pressed by a spring means 5 against the mating ring 3. The spring means 5 has a bellows-like design, wherein the spring means 5 comprises rounded areas 5a which resiliently mutually connect ring-shaped disks 5b, and wherein the ring-shaped disks 5b are resiliently movable against each other in the axial direction of the shaft 2. This mechanical face seal has low friction.

During the operation, an air gap 6 is formed between the primary ring 1 and the mating ring 3. The spring means 5 sits on an application surface 7 on the shaft 2. The spring means 5 can be attached by press fit or with intercalation of a sealant on the shaft 2. The sealant can be in the form of an elastomer or a lacquer.

The spring means 5 can be manufactured from metal. The spring means 5 can also be manufactured from a plastic composite material. The spring means 5 is applied against a contact surface 8 on the primary ring 1. The mating ring 3 is applied against a seat surface 9 on the housing 4. The shaft 2 is manufactured from steel. The housing 4 is manufactured from die cast aluminum. The primary ring 1 and the mating ring 3 have a design with a rectangular cross section.

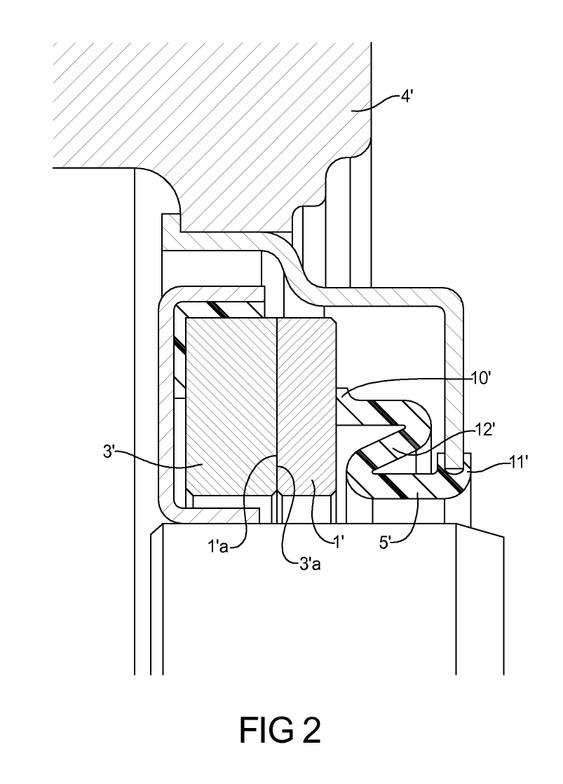

FIG. 2 shows a mechanical face seal comprising a primary ring 1′ which is axially movably mounted, and a mating ring 3′, wherein the primary ring 1′ and the mating ring 3′ each have adjoining sealing surfaces 1′a, 3′a, wherein the sealing surface 1′a of the primary ring 1′ faces the sealing surface 3′a of the mating ring 3′, and wherein the primary ring 1′ is pressed by a spring means 5′ against the mating ring 3′. The spring means 5′ has a bellows-like design.

The spring means 5′ can be manufactured from a plastic. The spring means 5′ can be manufactured from an elastomer. The elastomer has a Young's modulus in the range of 10-100 N/mm² and a compression set of less than 30%.

The bellows-like spring means 5′ is applied with a ring-shaped abutment area 10′ on the primary ring 1′, and secured with a ring-shaped connection area 11′ to a housing 4′, wherein the abutment area 10′ and the connection area 11′ are connected to each other by means of at least one resiliently deformable hinge area 12′. The hinge area 12′ has a design with an S-shaped cross section. The primary ring 1′ and the mating ring 3′ have a design with a rectangular cross section.

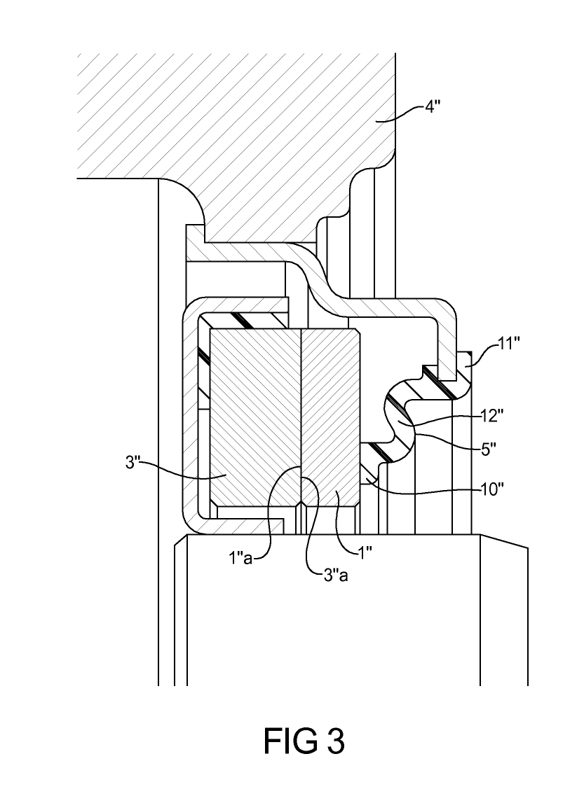

FIG. 3 shows a mechanical face seal comprising a primary ring 1″ which is axially movably mounted, and a mating ring 3″, wherein the primary ring 1″ and the mating ring 3″ each have adjoining sealing surfaces 1″a, 3″a, wherein the sealing surface 1″a of the primary ring 1″ faces the sealing surface 3″a of the mating ring 3″, and wherein the primary ring 1″ is pressed by a spring means 5″ against the mating ring 3″. The spring means 5″ has a bellows-like design.

The spring means 5″ can be manufactured from a plastic. The spring means 5″ can be manufactured from an elastomer. The elastomer has a Young's modulus in the range of 10-100 N/mm² and a compression set of less than 30%.

The bellows-like spring means 5″ can be applied with a ring-shaped abutment area 10″ on the primary ring 1″, and secured with a ring-shaped connection area 11″ to a housing 4″, wherein the abutment area 10″ and the connection area 11″ are connected to each other by means of at least one resiliently deformable hinge area 12″. The hinge area 12″ has a design with an S-shaped cross section.

The primary ring 1″ and the mating ring 3″ have a design with a rectangular cross section.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A mechanical face seal comprising:
a primary ring (1, 1′, 1″) which is axially movably mounted, and a mating ring (3, 3′, 3″);
wherein the primary ring (1, 1′, 1′) and the mating ring (3, 3′, 3″) each comprise adjoining sealing surfaces (1a, 1b, 1′a, 3′a, 1″a, 1″b);
wherein the sealing surface (1a, 1′a, 1″a) of the primary ring (1, 1′, 1″) faces the sealing surface (3a, 3′a, 3″a) of the mating ring (3, 3′, 3″); and
wherein the primary ring (1, 1′, 1″) is pressed by a spring (5, 5′, 5″) against the mating ring (3, 3′, 3″), wherein the spring (5, 5′, 5″) has a bellows-like design and the spring is manufactured from an elastomer without fiber reinforcements.

2-4. (canceled)

5. The mechanical face seal according to claim 1, wherein an elastomer of the spring has a Young's modulus in the range of 10-100 N/mm².

6. The mechanical face seal according to claim 1, wherein the bellows-like spring (5, 5′, 5″) is applied with a ring-shaped abutment area (10′, 10″) on the primary ring (1′, 1″), and secured with a ring-shaped connection area (11′, 11″) to a housing (4′, 4″);
wherein the abutment area (10′, 10″) and the connection area (11′, 11″) are connected to each other by at least one resiliently deformable hinge area (12′, 12″).

7. The mechanical face seal according to claim 1, wherein the spring (5) comprises rounded areas (5a) which resiliently connect ring-shaped disks (5b) to each other, wherein the ring-shaped disks (5b) are resiliently movable against each other in the axial direction of the shaft (2).

8. The mechanical face seal according to claim 1, wherein the primary ring (1, 1′, 1″) and the mating ring (3, 3′, 3″) have a design with square or rectangular cross section.

9. The mechanical face seal according to claim 1, wherein the mechanical face seal is a gas lubricated seal.
